(19) United States
(12) Patent Application Publication
(10) Pub. No.: US 2013/0069583 A1
(43) Pub. Date: Mar. 21, 2013

(54) POWER MODULE FOR PORTABLE DEVICES

(71) Applicants: Brian Lemelman, Juno Beach, FL (US); David Lemelman, New York, NY (US); Alexandra Lemelman, New York, NY (US); Frank Dunn, Austin, TX (US)

(72) Inventors: Brian Lemelman, Juno Beach, FL (US); David Lemelman, New York, NY (US); Alexandra Lemelman, New York, NY (US); Frank Dunn, Austin, TX (US)

(73) Assignee: THIRD RAIL MOBILITY, LLC., Juno Beach, FL (US)

(21) Appl. No.: 13/700,678

(22) PCT Filed: May 27, 2011
(86) PCT No.: PCT/US11/38423

§ 371 Date: Nov. 28, 2012

Related U.S. Application Data
(60) Provisional application No. 61/349,935, filed on May 31, 2010.
(60) Provisional application No. 61/383,878, filed on Sep. 17, 2010.
(60) Provisional application No. 61/385,509, filed on Sep. 22, 2010.
(60) Provisional application No. 61/411,283, filed on Nov. 8, 2010.

(51) Int. Cl. H02J 7/00

(52) U.S. Cl. 320/107

(57) ABSTRACT

A universal power management system is described, consisting of interchangeable, easy to remove, and connectable Universal Power Modules (UPMs), smartphone skins and doors, and applications to automatically manage the power charging of multiple devices. The system is compatible with various portable electronic devices.

### INCORPORATION BY REFERENCE

### Cross-Reference to Related Applications

This application claims priority to U.S. Provisional Application Nos. 61/349,635, filing date: May 28, 2010; 61/383,878, filing date: Sep. 17, 2010; 61/385,509, filing date: Sep. 22, 2010; and 61/411,283, filing date: Nov. 8, 2010, the entire contents of each are incorporated herein by reference.

All patents, patent applications and publications cited herein are hereby incorporated by reference in their entirety in order to more fully describe the state of the art as known to those skilled therein as of the date of the invention described herein.

### INTRODUCTION

There has been a massive proliferation of portable consumer electronic (CE) devices such as mobile phones (traditional cell phones and smartphones), MP3 players, handheld games, and eBook-readers that use battery power to fuel increasingly power-intensive applications and capabilities. However, even with the major technological advancements of portable CE devices, battery technology has been relatively stagnant, preventing OEMs from adding power-intensive features and limiting how the user is able to utilize the device.

### SUMMARY

A universal power management system is described, consisting of interchangeable, easy to remove, and connectable Universal Power Modules (UPMs), smartphone skins and doors, and applications to automatically manage the power charging of multiple devices. The system is compatible with various portable electronic devices.

UPMs include communication and power input/output ports (e.g., USB ports, such as “micro-USB” ports currently used to charge and interface with many smartphones). UPMs may be connected to devices through specific skins or doors to extend the intended devices' battery life. In one aspect, the UPMs have identical or compatible form factors so that the UPM can be readily incorporated into various systems without the need to reengineer the modules. In other aspects, the form factors can vary. Accommodation to different devices can be made by adaptation of the appropriate skin/battery door that can vary to fit each unique device. Additionally, each UPM contains an Inter-Module Interconnect (IMI) bus which provides connectivity, management and inter-module power transfer between UPMs and/or between a UPM and a device. Each UPM also includes a charging circuit, which accepts power from an external source and manages the transfer of power to the battery in a safe and effective manner. UPMs also include processors that manage the transfer of charge among UPMs and portable devices. These processors communicate via the IMI bus and execute firmware instructions stored in a computer-readable memory.

In one or more embodiments, the UPM includes a single wire, self configurable bus, for example, the single wire is BUS3. The self configuration is the result of the protocol definition. The protocol is one way for the bus to self configure when various items (cables, UPMs, etc) are plugged/unplugged or batteries are full, etc.

In one or more embodiments, the UPM is configured for DC/DC conversion. In the DC/DC converter, USB power (typically 5V+/−0.25V) is provided using standard or micro USB connectors as well as others non-standard connectors such as the Apple 30 pin connector. Given the global trend to standardize on the micro USB connector to provide local low voltage power for such purposes as charging, the UPM can be used as a power platform for a range of devices and provides flexibility and inter-connectivity for the user.

### BRIEF DESCRIPTION OF THE DRAWINGS

The invention is described with reference to the following figures, which are presented for the purpose of illustration only and are not intended to be limiting:

FIG. 1 illustrates a power management system including three UPMs according to one or more embodiments.

FIG. 2 is a perspective view of a two piece housing that integrates with the portable device according to one or more embodiments.

FIG. 3 is a perspective view of a case and an attached UPM according to one or more embodiments.

FIG. 4 is a perspective view of the front sides of a two piece housing according to one or more embodiments.

FIG. 5 shows a top view and a side-end view of a UPM according to certain embodiments described herein.

FIG. 6 shows the process of stacking two UPMs together using a hook and hook-receiver mechanism according to one or more embodiments.

FIG. 7 shows a functional diagram of a stack of three UPMs connected to a smartphone via an IMI bus to form a power hub according to one or more embodiments.

FIG. 8 shows a power hub created from two UPMs, in which the UPMs are powered (charged) from various sources such as (left) a wall socket, (top) another UPM, or (right) an laptop according to one or more embodiments.

FIG. 9 shows a stand-alone power hub (left) according to one or more embodiments that may be used to charge a single device and (right) used to charge two portable devices at the same time.

FIG. 10 shows a UPM stack according to one or more embodiments that can be charged from an AC power source, and can charge multiple portable electronic devices .

FIG. 11 illustrates a case with integrated UPM that can also serve as a power hub according to one or more embodiments.

FIG. 12 is an illustration of a UPM that is integrated into the back door of a device according to one or more embodiments.

FIG. 13A shows a back view of a two piece housing that integrates with a portable device according to one or more embodiments.

FIG. 13B shows a side view of a two piece housing that integrates with a portable device according to one or more embodiments.

FIG. 13C shows a back view of a two piece housing that integrates with a portable device with a UPM attached thereto and peripheral devices and a wall socket attached to the UPM, according to one or more embodiments.

FIG. 14 shows a replacement battery door 1401 attached to a device using the device's built-in battery-door connectors according to one or more embodiments.

FIG. 15 shows a UPM connected to a replacement battery door, and peripheral devices and a wall socket connected to the UPM, according to one or more embodiments.

FIGS. 16A, 16B, and 16C show back and side views of a two-piece housing that integrates with a portable device with no UPM attached, and also a back view of the housing with an attached UPM that is connected to peripheral devices and a wall socket, according to one or more embodiments.

FIG. 17 shows a back view of a two-piece housing that integrates with a portable device, and a UPM attached thereto, according to one or more embodiments.

FIG. 18 shows a side view of a two-piece housing that integrates with a portable device and a wall socket and a UPM attached thereto, according to one or more embodiments.

FIG. 19 shows a back view of a two-piece housing that integrates with a portable device and a UPM attached thereto, according to one or more embodiments.

FIG. 20 shows a side view of a two-piece housing that integrates with a portable device and a UPM attached thereto, according to one or more embodiments.

FIG. 21 shows a replacement battery door attached to a device using the device's built-in battery-door connectors according to one or more embodiments.

FIG. 22 shows a front view of a device that has a replacement battery door, according to one or more embodiments.

FIG. 23 shows a replacement battery door attached to a device using the device's built-in battery-door connectors, and a UPM attached thereto, according to one or more embodiments.

FIG. 24 shows a front view of a two piece housing that integrates with the portable device and a UPM attached thereto, according to one or more embodiments.

FIG. 25 shows a top view of a two piece housing that integrates with the portable device and a UPM attached thereto, according to one or more embodiments.

FIG. 26 shows a housing according to one or more embodiments with a stack of two

UPMs attached thereto.

FIG. 27 shows a side-end view of a UPM, according to one or more embodiments.

FIG. 28 shows a side view of a replacement battery door attached to a device using the device's built-in battery-door connectors, and a UPM attached thereto, according to one or more embodiments.

FIGS. 29A, 29B, and 29C show the integration of a Bluetooth headset with a UPM attached to a portable device, according to one or more embodiments.

FIGS. 30A and 30B show front and side views of a UPM with an integrated audio speaker, according to one or more embodiments.

FIG. 31 shows a Bluetooth headset with hooks for integrating with a UPM, according to one or more embodiments.

### DETAILED DESCRIPTION

The features of the universal power module system are described herein with reference to a smartphone; however, the system may be used with any portable device including without limitation, handheld electronic games, mp3 music players, e-book readers and similar devices.

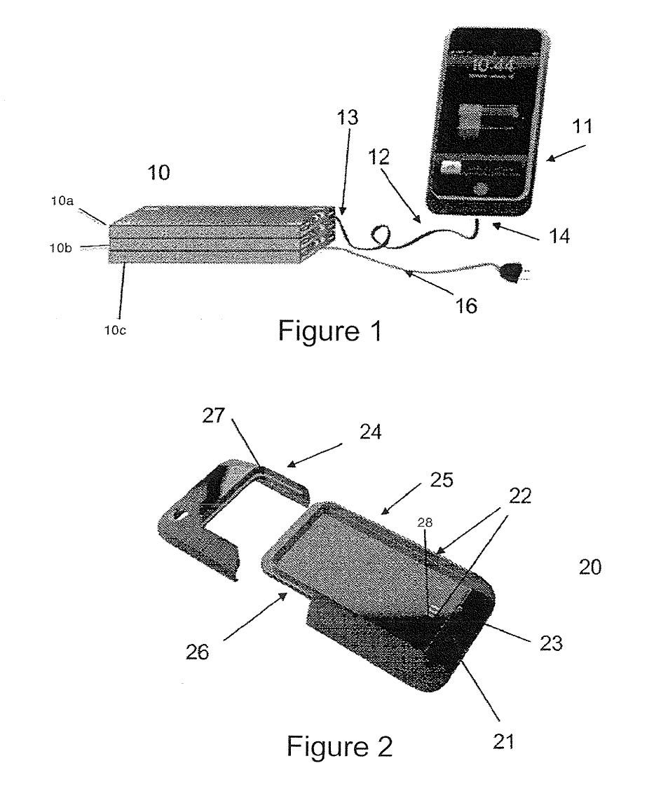

FIG. 1. shows one embodiment described herein, in which a stack of UPMs 10, containing UPM 10a, UPM 10b, and UPM 10c, is connected to a portable device, e.g., a smartphone 11 (an iPhone is shown here, but the invention described herein is intended for any smartphone or portable computing device, including but not limited to the devices listed above). A feature of the power management system is the ability to connect UPMs to one another or to a variety of other energy sources and/or electronic devices, providing extended energy capacity and device operation time and versatile distribution of power among various electronic devices and UPMs. FIG. 1 illustrates a power management system including three UPMs connected via an IMI bus (not shown) to form a UPM stack; however, the system can operate with any number of UPMs. By way of example, a single UPM may be employed, or two or more UPMs can be combined. The number of UPMs that can be stacked is not limited; however, considerations such as bulk and weight may provide practical limitations to the number of UPMs that can be stacked together.

Each UPM contains a battery capable of storing electric charge, and a charging circuit that interfaces with this battery. The charging circuit regulates the voltage and the current used to charge the battery, and monitors the battery's voltage in order to determine when to start and stop charging. There exist a number of commercially available charging circuits that are intended for use in devices with rechargeable batteries, such as the Texas Instruments BQ24150A and the Freescale Semiconductor MC34673 (the datasheets of which are incorporated into this application and enclosed as Appendix A and Appendix B, respectively). The present invention is not limited to any particular model or variety of charging circuit.

As described above, the charging circuit accepts power from an external source and manages the transfer of power to the UPM's battery in a safe and effective manner. This involves several tasks, which may be one or more of determining the current charge status of the UPM's battery, monitoring the current of the charge, controlling the transfer of charge in either a current-controlled or voltage-controlled manner, and determining when to terminate the transfer of charge (including termination due to unsafe charge conditions).

Portable devices that use removable batteries commonly house a charging circuit either within the chassis of the device or in a separate charging module. When the charging circuit is included in the device itself, the battery can only be charged when inserted into the device, and cannot be charged separately. Including the charging circuit in a dedicated charging module as is known in the prior art allows the battery to be charged separately, but reduces portability and convenience by forcing the user to carry a separate charger.

By contrast, the UPM bundles the charging circuit together with the battery. Including the charging circuit within the housing of the UPM serves several purposes. It improves portability because it does not require the user to carry a separate charger; the UPM may be charged with nothing more than a standard micro/USB power cable and a power source (e.g., a laptop or wall socket). It also allows for the stacking of an arbitrary number of UPMs (as just UPMs or even on a case): bundling the charging circuit inside the UPM ensures that each battery is managed by a dedicated charging circuit. This allows for, among other things, individual control and monitoring of each battery's charge level, and facilitates the “smart” charging algorithms described below, which involve the selective charging of particular batteries in a UPM stack.

The stack of UPMs 10 can be connected to the portable device 11 using a device-specific cable 12, across which charge and/or data may be transferred from the stack of UPMs 10 to the smartphone 11. The device-specific cable 12 may also convey charge and/or data bidirectionally. One end of the device-specific cable 12 attaches to a charge output port of one of the UPMs 13. The other end 14 of the device-specific cable 12 attaches to the smartphone 11 itself A universal cable may also be used to connect the stack of UPMs 10 to the portable device 11.

When the stack of UPMs 10 is attached to the smartphone 11 using a device-specific cable, the UPMs act as a power source for smartphone 11—functionally equivalent to plugging smartphone 11 into a wall power source or charging it via another device such as a desktop or laptop computer. The stack of UPMs 10 periodically queries the internal battery state of the smartphone 11. When the smartphone's internal battery is 100% charged, the UPM substantially turns off transfer of charge to the phone. When the internal battery charge state reaches a threshold value (e.g., 97%), the UPM begins to charge the internal smartphone battery. The threshold can be set at any value ranging from less than 100% to more than 0%; however, the threshold is typically set high (e.g., 90-99%) so that the smartphone internal battery remains substantially fully charged. Additionally, the housing of the UPM may include a button (not shown) operable to turn on/off the charging of the smartphone's internal battery by the UPM. By substantially shutting off the transfer of charge from the UPM to the smartphone, and only engaging charge transfer when needed, the UPM does not needlessly drain its stored charge and can therefore provide power to the external device for a much longer time.

The stack of UPMs 10 may also be connected to a power source such as a wall outlet, or a laptop or desktop computer. A power-input cable 16 connects a power source to a charge input port of one of the UPMs in the stack 10. When a stack of UPMs such as the stack 10 is connected to a power source using a power-input cable, the stack of UPMs is collectively charged as described below. Suitable power input cables include, but are not limited to, USB power cables and A/C plug cables. The stack of UPMs may be connected to the portable device and to an external power source simultaneously. This allows the portable device 11 and the UPMs 10 to be charged at the same time.

In certain embodiments, the UPM can be inserted into a housing, case, or panel that integrates with the portable device. FIG. 2 shows an exemplary case 20, according to some embodiments described herein, that is intended to house a portable device such as a cell phone. The case is shown in perspective view with the back face of the casing (e.g., the side of the case facing away from the device) visible. The case is separable into upper 24 and lower 25 sections to provide a conformal fit of the device within the case. The two sections of the case can be joined using a variety of mechanisms. As shown in FIG. 2, rib 26 of lower section 25 mounts in a sliding fashion into channel 27 of the upper section 24.

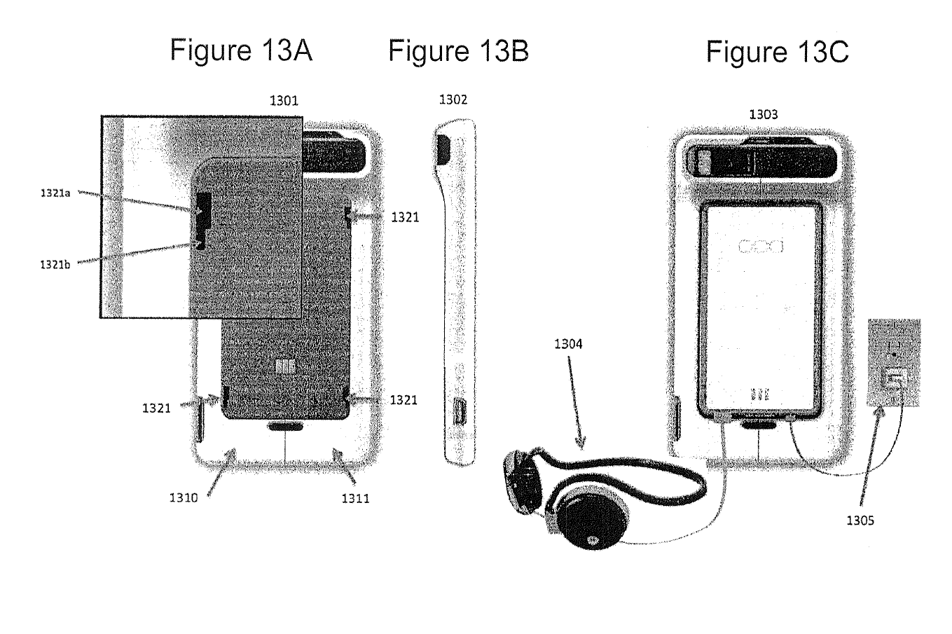

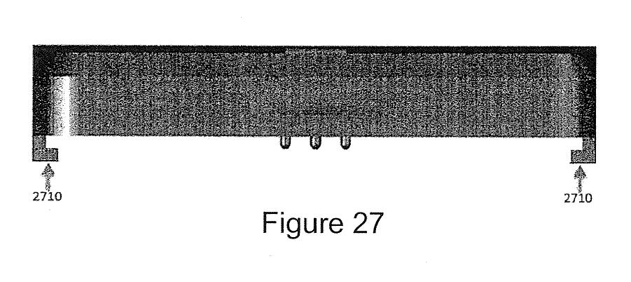

In an alternative embodiment, the case may be horizontally separable, as shown in FIGS. 13A-C. FIGS. 13A-C show a case separable into left 1310 and right 1311 portions. As with cases separable into upper and lower portions, horizontally separable cases may join the right and left portions using a variety of mechanisms, including the rib-and-channel method illustrated in FIG. 2. FIG. 13A shows a back view 1301 and FIG. 13B shows a side view 1302 of a horizontally separable case. FIG. 13C shows the case with a UPM attached. Additionally, the UPM's battery or the device's internal battery can be charged directly by connecting the UPM to a power supply, such as wall socket 1305. Also, the UPM can be used to charge external devices, such as a Bluetooth audio device 1304. The UPM is capable of charging the smartphone and/or external devices even when it is not connected to a wall socket or other power supply. The case shown in FIGS. 13A-C includes mechanical slots 1321 that are used to receive the hooks of a UPM. Slots 1321 contain an upper wider portion 1321a and a lower narrower portion 1321b, as shown in the upper left, magnified portion of FIG. 13A. As shown in FIG. 27, the bottom of the UPM has “hooks” 2710 that may be used to attach the UPM to a portable device or to another UPM. To attach a UPM to the case, the hooks 2710 of the UPM are inserted into the upper wider portions 1321a of slots 1321, which are able to receive the hooks. That is, the hooks are narrower than upper slot portion 1321a. The UPM assembly then is shifted downward to engage the hook shank with the lower narrower portion 1321b of slot 1321 to secure the connection to the case. Hook 2710 has a flange or rim or lip that is wider than the narrow portion 1321b of slot 1321 and is used to secure the UPM to the case. The length of the shaft can vary, but is typically of a length that minimizes the extension of the hook beyond the case inner surface. It is desirable that the hook has a depth to provide clearance and to be spaced apart from the device.

In an alternative embodiment, the case is comprised of a single piece of flexible material that conforms with and “snaps” on to the back of the case of the portable phone.

The case includes a mechanism for attaching the UPM to the case. Referring to FIG. 2, the back of the case includes a UPM connection assembly 21 for receiving a UPM. The connection assembly includes a space or region on the back face of the case that is adapted to receive a UPM. The space may be a hollow or a depression in the back face of the case or it can be flush with the rest of the back face of the case. The space can be a compartment with one or more raised sides such as is illustrated in FIG. 2. Alternatively, the space may be a substantially flat region on the back face of the case that contains connectors for securing the UPM to the case. The UPM connection assembly includes IMI contacts 28 that connect the complementary IMI connectors of a UPM (IMI contacts and IMI connectors are described in more detail below). Cases can be made of rigid or flexible material. In additional, other designs for encasing the device requiring only one section are contemplated (e.g., the snap-on case described above).

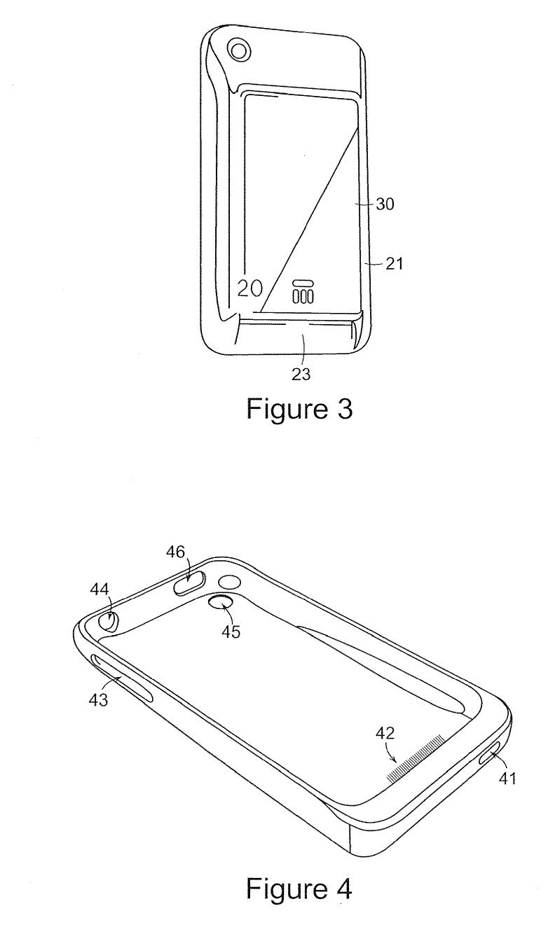

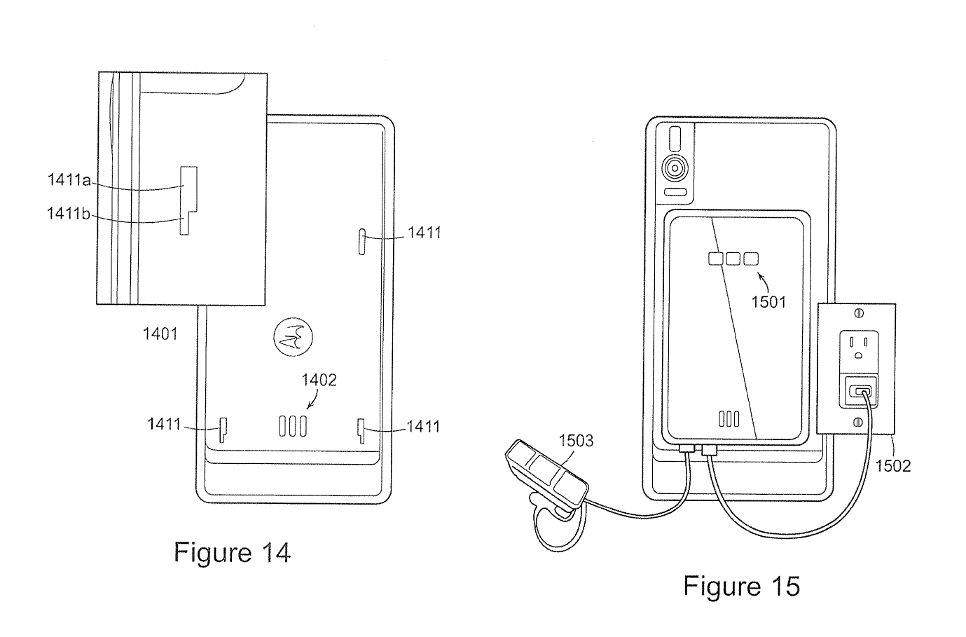

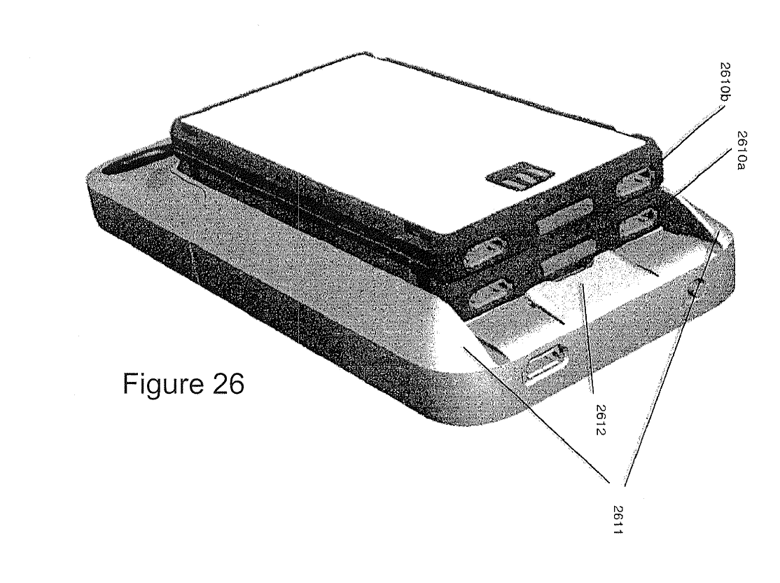

With reference to FIG. 2, to insert a UPM into the connection assembly, a user slides a UPM into a UPM compartment between rails 22 and catch 23 (see also FIG. 26, showing UPM 2610a inserted into the space between rails 2611 and catch 2612, with an additional UPM 2610b attached to UPM 2610a). When the UPM has been fully inserted into the compartment, it is held in place by retention latch 23. FIG. 3 shows the case 20 with a UPM 30 inserted into UPM compartment 21. To remove a UPM from the connection assembly, a user releases retention latch 23. Although the case pictured in FIG. 2 uses rails 22 to secure a UPM in the connection assembly 21, the connection assembly can include a wide variety of connectors that may be used for this purpose, including but not limited to magnetic connections, Velcro™ connectors, hooks, studs, latches, dovetails, snaps, elastics, etc. The connection method may also use mechanical slots and hooks as described below with reference to FIGS. 14, 15, and 16A-C.

As shown in FIG. 27, the bottom of the UPM has “hooks” 2710 that may be used to attach the UPM to a portable device or to another UPM.

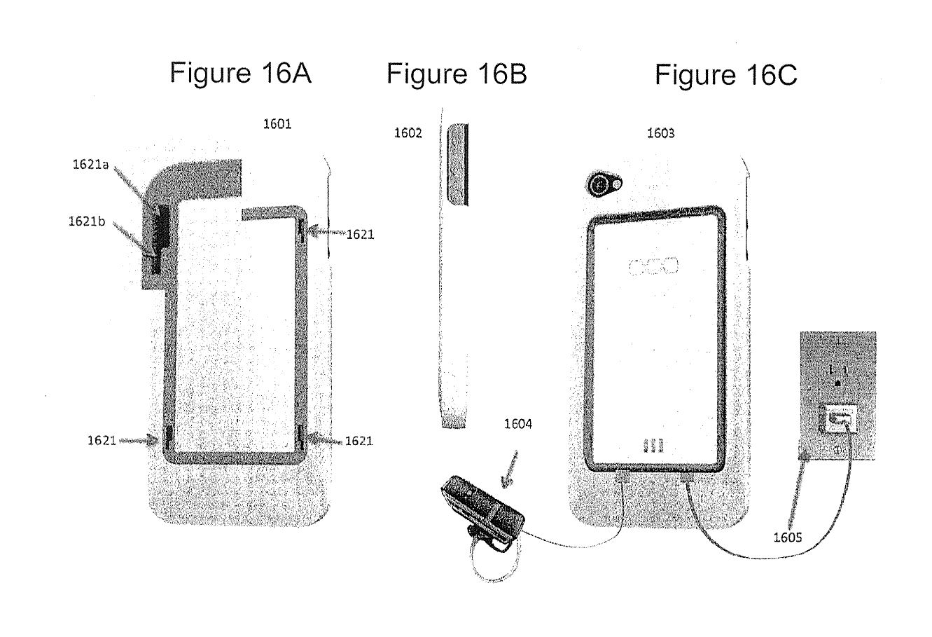

According to some embodiments, the hooks 2710 of a UPM can be used to secure the UPM to the removable case or detachable battery panel. FIGS. 16A-C show a case with slots 1621 used to attach a UPM. Slots 1621 contain an upper wider portion 1621a and a lower narrower portion 1621b, as shown in the upper left, magnified portion of FIG. 16A. To attach a UPM to the case, the hooks 2710 (see FIG. 27) of the UPM are inserted into the upper wider portions 1621a of slots 1621, which are able to receive the hooks. That is, the hooks are narrower than upper slot portion 1621 a. The UPM assembly then is shifted downward into engage the hook shank with the lower narrower portion 1621b of slot 1621 to secure the connection to the case. Hook 2710 has a flange or rim or lip that is wider than the narrow portion 1621b of slot 1621 and is used to secure the UPM to the case. The length of the shaft can vary, but is typically of a length that minimizes the extension of the hook beyond the case inner surface. It is desirable that the hook has a depth to provide clearance and to be spaced apart from the device.

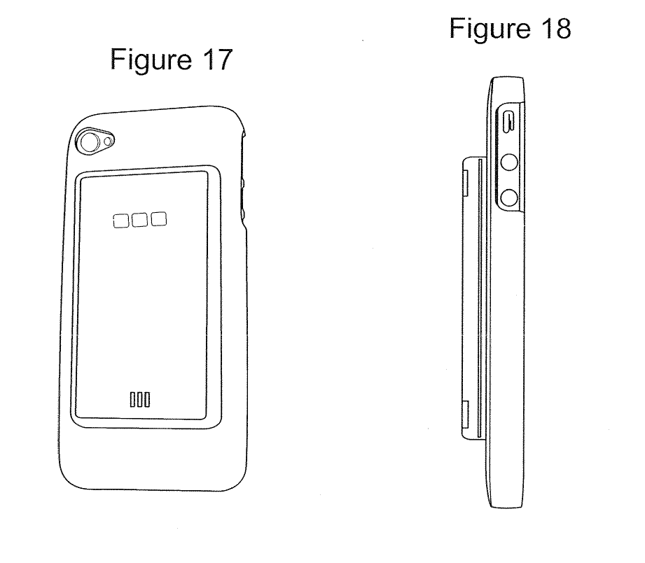

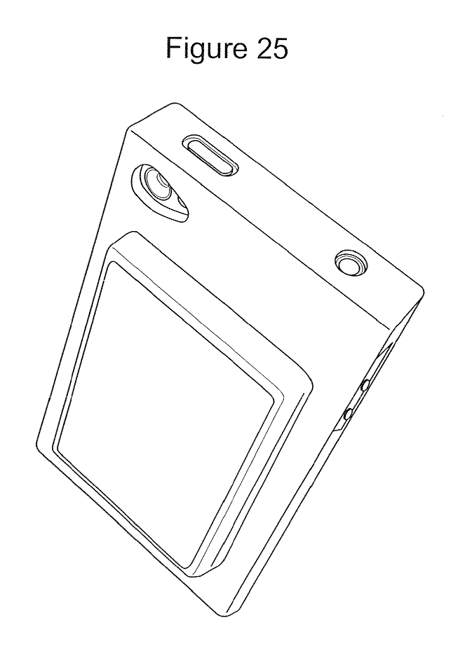

FIG. 16A shows a back view of case 1601 without a UPM inserted. FIG. 16B shows a side view 1602 of the case without the UPM. FIG. 17, FIG. 18, and FIG. 25 show back, side, and top views, respectively, of case 1603 with a UPM inserted. FIG. 16C shows a view of case 1603 with peripheral devices attached to the inserted UPM. When a UPM is inserted, the UPM's battery may be used to provide charge to the device's internal battery. Additionally, the UPM's battery or the device's internal battery can be charged directly by connecting the UPM to a power supply, such as wall socket 1605 or PC, MAC, or other personal computing device. Also the case has a sync/charge port to allow for charging of the portable device, UPM, and whatever external devices are connected to the UPM. The sync/charge port also allows for data transfer (e.g. syncing to iTunes). Also the UPM has a sync/charge port to allow for charging of the portable device, UPM, and whatever external devices are connected to the UPM. The sync/charge port also allows for data transfer (e.g. syncing to iTunes). Generally speaking, any device that may be charged using the charging ports on the UPM may also be charged using the sync/charge port on the case, and vice versa. Also, the UPM can be used to charge external devices, such as a Bluetooth audio device 1604.

The embodiment shown in FIGS. 16A-C has the advantage of maintaining a sleek profile when a UPM is not attached to the slots on the back of the case. The back of the case is substantially flat, as can be seen in side view 1602. Thus, when a UPM is not attached, there are no protrusions or large cavities that might make the handheld device difficult to use, hold, or carry. When attaching a UPM to the back of the case, the hooks of the UPM slide into the slots on the back of the case and form a connection. The attached UPM rests flush against the back of the case.

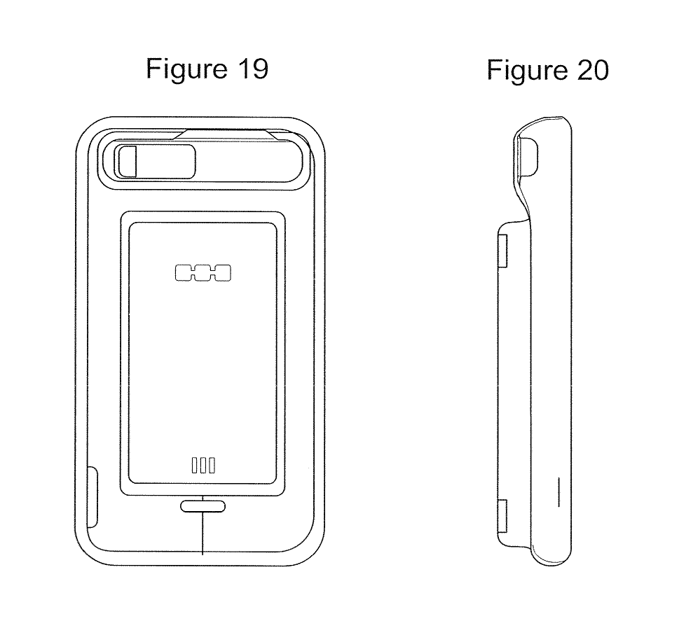

FIG. 13A, FIG. 13B, and FIG. 24 show back, side, and front views, respectively, of another “substantially flat” embodiment (such as the embodiment described above with reference to FIGS. 16A-C) with no UPM attached. FIG. 19 and FIG. 20 show back and side views, respectively, of this embodiment with an attached UPM. FIG. 13C shows a back view of this embodiment with an attached UPM and peripheral devices.

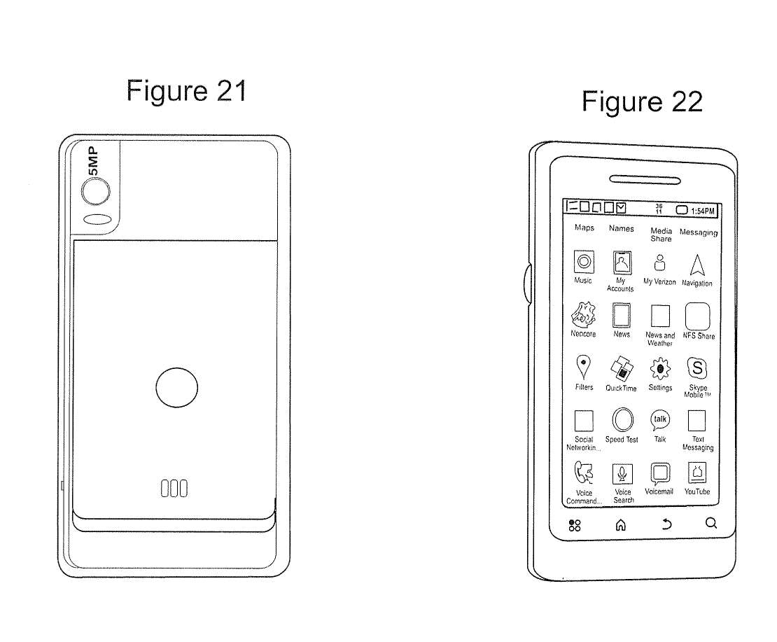

Hooks and mechanical slots may also be used to attach a UPM to a removable battery panel, as shown in FIG. 14 and FIG. 21. A replacement battery door 1401 is attached to the device using the device's built-in battery-door connectors (not shown) used to connect the device-provided battery door. The replacement battery door 1401 includes charging contacts 1402 that are configured to be in electrical contact with the device's internal battery and that can be used to charge the device's internal battery using a UPM. The charging contacts 1402 are connected to the internal battery of the device according to various device-specific methods (for example, many RIM BlackBerry devices provide an external charging interface used to charge the internal battery when the device is placed in a docking cradle; this interface may also be used to charge the internal battery using a UPM). Charging interfaces are generally device-specific, and may employ one of a number of known charging methods, including but not limited to charging by USB cable, inductive charging, external charging contacts, etc.

The replacement door includes mechanical slots 1411 that are used to receive the hooks of a UPM. Slots 1411 contain an upper wider portion 1411a and a lower narrower portion 1411b, as shown in the upper left, magnified portion of FIG. 14. To attach a UPM to the replacement door, the hooks 2710 of the UPM are inserted into the upper wider portions 1411a of slots 1411, which are able to receive the hooks. That is, the hooks are narrower than upper slot portion 1411a. The UPM assembly then is shifted downward into engage the hook shank with the lower narrower portion 1411b of slot 1411 to secure the connection to the case. Hook 2710 has a flange or rim or lip that is wider than the narrow portion 1411b of slot 1411 and is used to secure the UPM to the replacement door. The length of the shaft can vary, but is typically of a length that minimizes the extension of the hook beyond the door inner surface. It is desirable that the hook has a depth to provide clearance and to be spaced apart from the device (the location of the wider and narrower portions is arbitrary and can also be reversed). When the hooks are inserted into the mechanical slots 1411, the UPM is shifted downward to secure the connection between the UPM and the battery door 1401. When attached, the UPM uses charging contacts 1402 to provide charge to the internal battery.

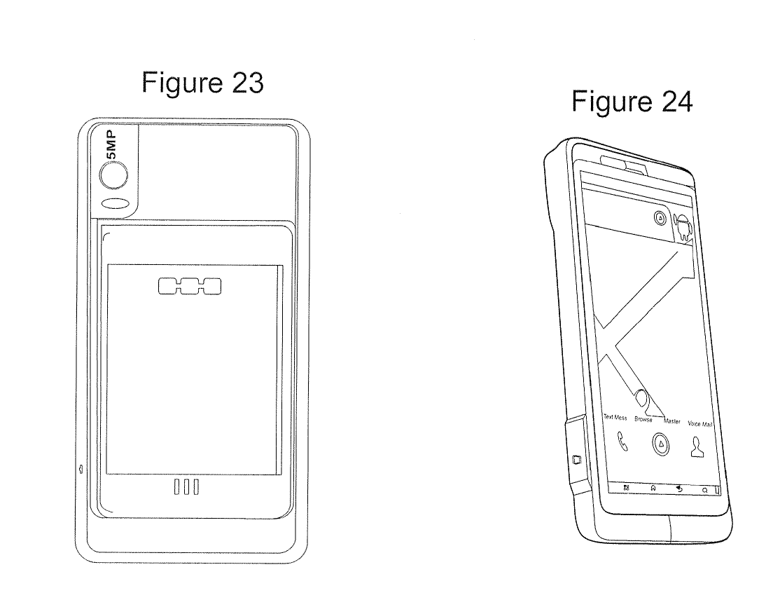

FIG. 15 and FIG. 23 show a UPM 1501 connected to the replacement battery door. When attached to the door, the UPM's battery may be used to provide charge to the device's internal battery. Additionally, the UPM's battery and/or the device's internal battery can be charged directly by connecting the UPM to a power supply, such as wall socket 1502. Also, the UPM can be used to charge external devices, such as a Bluetooth audio device 1503. A front view of this embodiment is shown in FIG. 22.

Alternatively, a door including slots or other means for connecting a UPM and charging contacts or other means for charging a UPM may already be provided by the manufacturer of the portable device, in which case no replacement battery door is necessary. Similarly, a manufacturer might provide a portable device without a battery door, but having a surface containing slots or other means for connecting a UPM and charging contacts or other means for charging a UPM. In these two scenarios, a UPM may be attached directly to the portable device without requiring a replacement battery door or an external case.

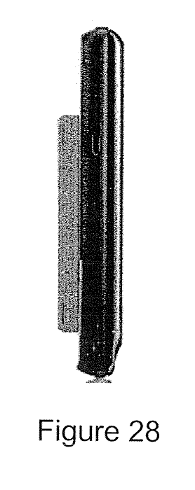

As with the case described above, the replacement battery door shown in FIG. 14 and FIG. 15 also has the advantage of maintaining a sleek profile when a UPM is not attached to the slots on the back of the door. The back of the replacement battery door is substantially flat, as can be seen in FIG. 28. Thus, when a UPM is not attached, there are no protrusions or large cavities that might make the handheld device difficult to use, hold, or carry. When attaching a UPM to the back of the replacement battery panel, the hooks of the UPM slide into the slots on the back of the panel and form a connection.

FIG. 4 shows the front side of the case 20 that is illustrated in FIG. 2. As illustrated, the case may include one or more “pass-through” ports 41 (e.g., micro-USB ports, as shown) to provide access to the smartphone's communication and power I/O ports from the outside of the case. These pass-through slots allow data to be transferred to and from the smartphone, and they also enable the user to charge the internal battery of the smartphone directly. According to certain embodiments, the pass-through ports 41 allow the user to charge not only the internal battery of the smartphone, but also any UPMs that are attached to the case or attached via an external cable, and also any external devices that are attached to the case or attached via an external cable.

Additionally, the case can connect directly to the data/power input ports of the portable device, and thereby ensure that a UPM is automatically connected to the portable device when it is inserted into the connection assembly. The case may also optionally include an on/off switch to control power transfer from UPM to phone. In the case shown in FIG. 4, this connection is achieved via connector 42. In this embodiment, the case subsumes the functionality of the device-specific cable 12 described above. Other types of connections may be used, such as a standard or micro-USB port, or a three-contact battery charging connector, as not all smartphones include the 30-pin iPhone connector shown in FIG. 4.

Some portable electronic devices, for example, Blackberry portable devices, include contacts for charging the internal battery on the outside of the housing. In such an instance, the case can include charging contacts to connect with the contacts on the housing of the portable device. Alternatively, the existing battery door of the smartphone may be replaced by a custom door designed to receive a UPM. This arrangement can include all of the functional features of the case shown in FIG. 2, FIG. 3, and FIG. 4. Other portable electronic devices have USB ports, circular power/data ports and other means to connect to a power source for recharging. According to some aspects, a case is designed to interface with these interconnects.

The case allows user access to the various buttons/ports that already exist on the sides/back of the smartphone device. If the smartphone includes a camera, the case may include an opening for the camera lens, ensuring that the camera can still be used even when the smartphone is enclosed in case 20. FIG. 4, for example, shows openings for volume controls 43, an audio output jack 44, a camera lens 45 and an on/off switch 46.

The case is intended to allow “hot-swappable” replacement of UPM power supplies. In other words, a UPM may be released, detached, and replaced by another UPM without interrupting the functionality of the portable device. Also, a new UPM can be plugged into the case USB port regardless of whether a UPM is on the case or not without interrupting the functionality of the portable electronic device. The processor and IMI bus of the UPM automatically detect that a device has been connected and, if necessary, instruct the UPM to begin transferring charge. It is not necessary to modify the portable device to implement this functionality since; as described above, attaching a UPM is functionally equivalent to plugging smartphone 11 into a wall power source or charging it via another device such as a desktop or laptop computer.

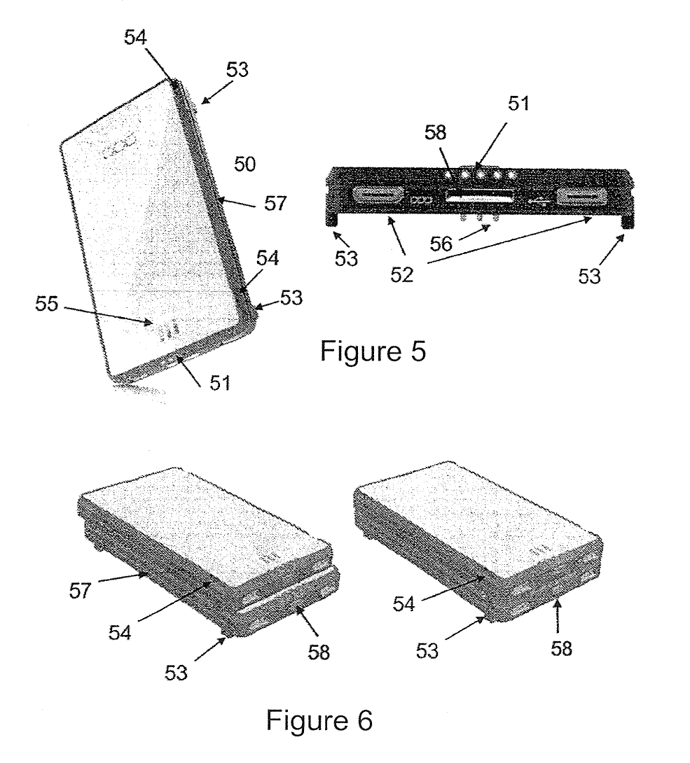

FIG. 5 shows a top view (left) and a side-end view (right) of a UPM according to certain embodiments described herein. A UPM comprises a battery power source inside a housing 50. To indicate the level of charge contained in the battery, LED indicators 51 are included on the outside of the housing. Alternatively, other types of indicators may be used, including LCDs, OLEDs, etc. These indicators 51 provide a rough approximation of the UPM's charge (e.g., a remaining charge of 60% might be shown by lighting three out of five lights). Additionally, the LEDs can be used to indicate other events, such as: unplugging/detaching a UPM from a stack or a case, plugging/attaching a UPM into a stack or a case, plugging a charger into a UPM, transferring charge into or out of the UPM. The LEDs are arranged such that they can be viewed from the top and the side of the UPM, enabling a user to view the approximate remaining charge in the UPM even when the UPM is part of a UPM stack. This may be achieved, for example, by placing the LED indicators 51 on an angled plane (e.g., on the beveled edge of the UPM), or by placing the LEDs in right-angle receptacles. Other arrangements of the LEDs can be used to permit visibility from both the upper and lower face of the UPM. The LED indicators 51 may be continually lit, or they may be activated by pressing a button 58 on the outer casing of the UPM. Alternatively, the LEDs can blink periodically. Activating the LEDs for a limited amount of time after the button has been pressed helps to conserve power. LEDs may also use different colors to convey information (e.g. a green LED may be used to indicate that the UPM's internal battery is full, while a red LED may be used to indicate that it is empty, or the LEDs may be used to indicate the relative levels of charge among a group of UPMs, to name just a few). LEDs such as alphanumeric LEDs may also be employed to convey various information to the user, such as the percentage of battery charge remaining

The UPM also includes multiple ports 52 (shown in FIG. 5 as micro-USB ports). The ports can handle charge and/or data and can be input or output only ports or input/output bidirectional ports. These ports can be both connected to portable devices such as smartphones or other UPMs in order to provide power to the portable device, and also connected to power sources such as wall sockets or laptop/desktop computers, in order to charge the UPM. Note that the UPM is not limited to the use of micro-USB connectors, nor is it limited to only 2 ports. Any type of electrical connector suitable to transfer charge or data may be used to connect UPMs to portable devices (such as “pogo-style” connectors). These connectors may serve as input-only, output-only, or bidirectional connectors.

As described above, several UPMs can be used functionally as a single power supply unit by stacking them together. Mechanically, this stacking is effected using hooks 53 and hook-receivers 54, although any type of mechanical connector may be used for this purpose.

The embodiment pictured in FIG. 5 uses “drop and slide” hooks: in this embodiment, a user stacks one UPM on top of another by inserting the hooks of one UPM into the hook-receivers of another, and then sliding laterally, locking the two UPMs in place. FIG. 6 shows the process of stacking two UPMs together. In the left view, the hooks 53 of the upper UPM are inserted into the hook-receivers 54 of the lower UPM. In the right view, the upper UPM has been moved forward relative to the lower UPM, securing the hooks in place. Hook 53 engages with a lip of hook-receiver 54 to retain the UPM in locked position. However, stacking is not limited to this particular type of mechanical connection. A wide variety of physical connectors, such as magnetic connections, velcro connectors, hooks, studs, latches, dovetails, snaps, elastics, etc., may be used to physically connect one UPM to another. A mechanical connection is not required for electrical connection transfer.

Electrically, the stacking of UPMs is effected using electrical contacts, although any type of electrical connector may be used for this purpose. When two UPMs are stacked one upon the other (as shown in FIG. 6) the IMI contacts 55 of one UPM are in electrical contact with the IMI connectors 56 of the other. Each UPM includes both IMI contacts 55 and IMI connectors 56, so it may be connected to two other UPMs (i.e., in the “middle” of a stack of UPMs) or to the appropriate IMI in the smartphone case. In the particular embodiment shown in FIG. 5, the IMI connectors 56 are “pogo” style connectors that are spring loaded to ensure a firm electronic connection with the IMI contacts 55 of the adjacent UPM. However, the invention disclosed herein is not limited to this particular type of connector. A wide variety of electric contacts, couplings, sockets, etc. may be used to implement the IMI connections, including non-physical contacts for data and/or power transfer, such as RF or inductive charge. The orientation of the stacking depends on the location of the charging contacts on the chassis of the UPM. For example, UPM modules with side-charging contacts would stack horizontally.

FIG. 5 and FIG. 6 also show rail grooves 57 that are used to secure the UPM when it is inserted into a case (such as the case shown in FIG. 2-4). Alternative methods of attaching a UPM to a case or battery door, such as the method using mechanical slots and hooks described above, may also be used. As described above, a wide variety of physical connectors, such as magnetic connections, velcro connectors, hooks, studs, latches, dovetails, snaps, elastics, etc., may be used to physically connect a UPM to a case or battery door.

When multiple UPMs are stacked together, they can communicate charge and/or data using the electronic IMI connections described above. Each UPM includes a memory containing firmware instructions and a processor to execute these firmware instructions. The processor and firmware allow a UPM to recognize events including but not limited to: when it is stacked with other UPMs, when it is connected to an external power source, and when it is connected to a portable device (these states are not mutually exclusive). Additionally, a UPMs in a stack can obtain charge information about the other UPMs in the stack via the IMI connection. In each of these states, the UPM's behavior will be determined by the appropriate firmware instructions. Note that the IMI bus connects UPMs to other UPMs, but also connects UPMs to portable devices such as smartphones In this way, all devices connected to a stack of UPMs (including the UPMs themselves) can be considered to be connected to a single IMI bus.

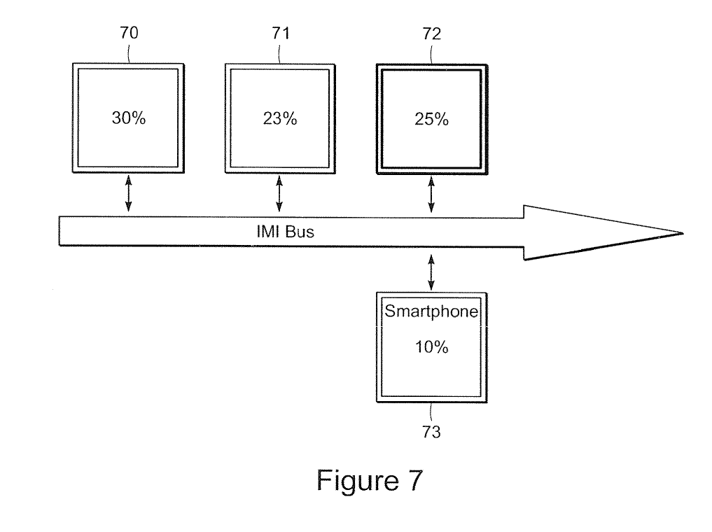

Multiple UPMs can be stacked to form a power-hub. For example, FIG. 7 shows a functional diagram of a stack of three UPMs 70 71 72 connected to a smartphone 73 via an IMI bus 74. In this scenario, the stack of three UPMs is used to power the smartphone, which has only 10% charge remaining Each of the UPMs in the stack is only partially charged. UPM 70 has 30% charge remaining; UPM 71 has 23% charge remaining; UPM 72 has 25% charge remaining.

According to some embodiments of the invention, power will automatically, as directed by firmware instructions, flow to the smartphone from the UPM in the stack with the least (nonzero) charge remaining In this case, the UPM with the least charge remaining is UPM 71, at only 23% of its capacity. When UPM 71 is drained of its power reserve, UPM 72 will become the UPM in the stack with the least nonzero charge remaining, and power will begin to flow from UPM 72 to the smartphone 73. This process continues until the smartphone is fully charged or all UPMs in the stack have been drained of their remaining charge. The charge-out behavior of stacked UPMs is determined by the firmware instructions executed by the UPMs' processors.

When a stack of UPMs is connected to an external power source, such as a wall socket or laptop/desktop computer, the reverse rule may apply. In these cases, power will automatically, as directed by firmware instructions, flow from the external power source to the UPM in the stack that is the closest to 100% capacity. For example, if a stack of three UPMs are charged to 40%, 80%, and 60% capacity, respectively, the second UPM (being the closest to 100% capacity) will first be charged to 100% capacity, using the power from the external source. After the second UPM is fully charged, the third UPM at 60% will be closest to 100%, and charge will flow from the external power source until the third UPM is fully charged. This process continues until all UPMs in the stack are fully charged. Alternatively, power may flow to all UPMs in a stack simultaneously or in reverse order, e.g., from lowest to highest power. The charge-in behavior of stacked UPMs is determined by the firmware instructions executed by the UPMs' processors.

Charge may also be transferred among the various UPMs in a stack of UPMs. For example, according to some embodiments of the invention disclosed herein, charge may be transferred from the least-charged member of a stack to the most-charged member of a stack, with the object of obtaining a single, fully-charged UPM to be detached from the stack and inserted into a case (such as that shown in FIG. 2). If a UPM or stack of UPMs is not currently charging a portable device such as a smartphone, power may automatically begin to be transferred among UPMs in the above-described fashion. The charge-transfer behavior of stacked UPMs is determined by the firmware instructions executed by the UPMs' processors. Charge is transferred among UPMs in order to ultimately have as many fully-charged UPMs as possible.

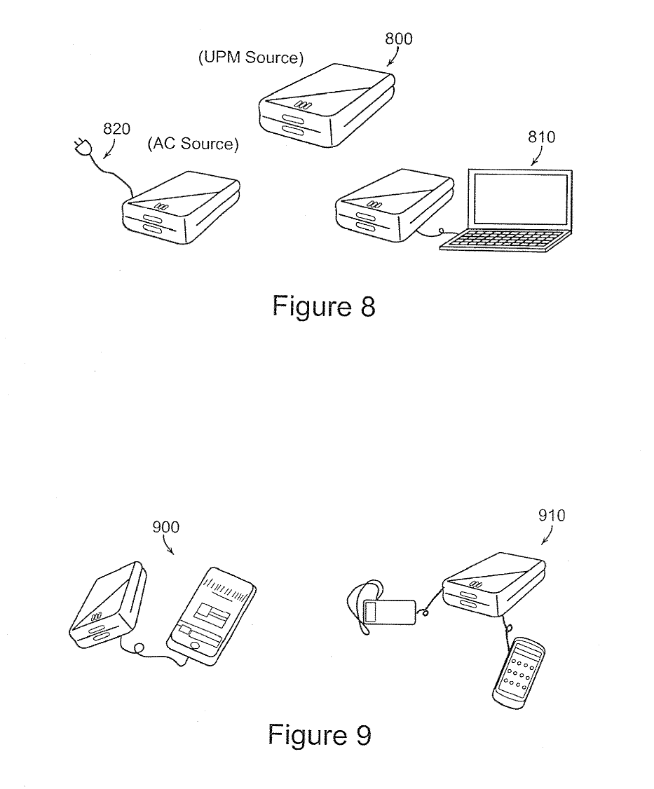

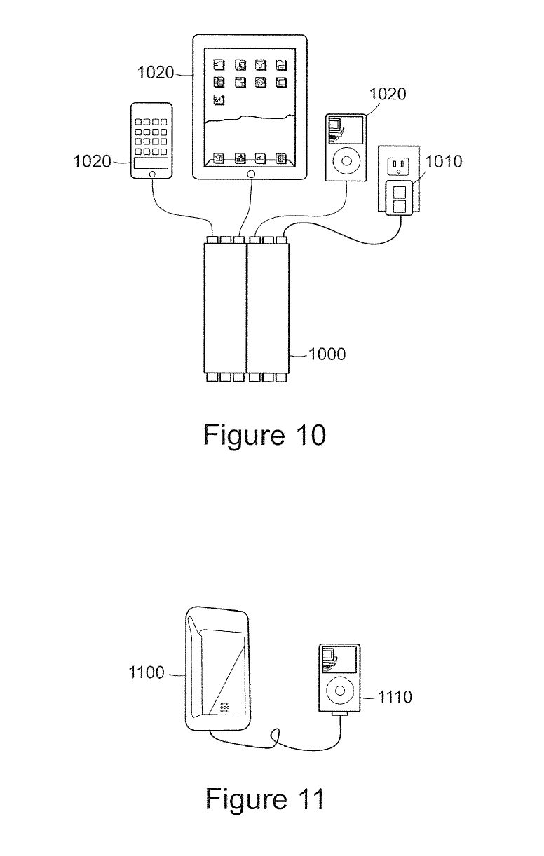

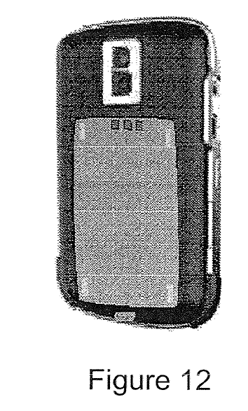

Note that it is possible to charge multiple devices at the same time using a UPM or stack of UPMs. This “power-hub” approach can be achieved by simply attaching more than one device to the UPM/UPM stack using ports 52. The UPM can serve as a charging hub, in which each UPM port in the stack can be charged from a variety of power sources. For example, FIG. 8 shows a power hub 800 created from two UPMs, in which one UPM charges the other. UPMs can be charged from external AC power source 820 or even from portable electronic devices 810. The UPM can be used as a stand alone power hub to charge other devices. For example, FIG. 9 shows a stand alone power hub 900 used to charge a single device and a power hub 910 used to simultaneously charge two portable devices. A stack of multiple UPMs can serve as a one plug power station for charging portable devices, while at the same time being charged (or maintaining its charge) by connection to an AC power source. For example, FIG. 10 shows a UPM stack 1000 that can be charged from an AC power source 1010. The UPM stack can charge multiple portable electronic devices 1020. A case with integrated UPM can also serve as a power hub, as illustrated in FIG. 11. In FIG. 11, a smartphone with case having an integrated UPM 1000 can charge another portable electronic device 1110.

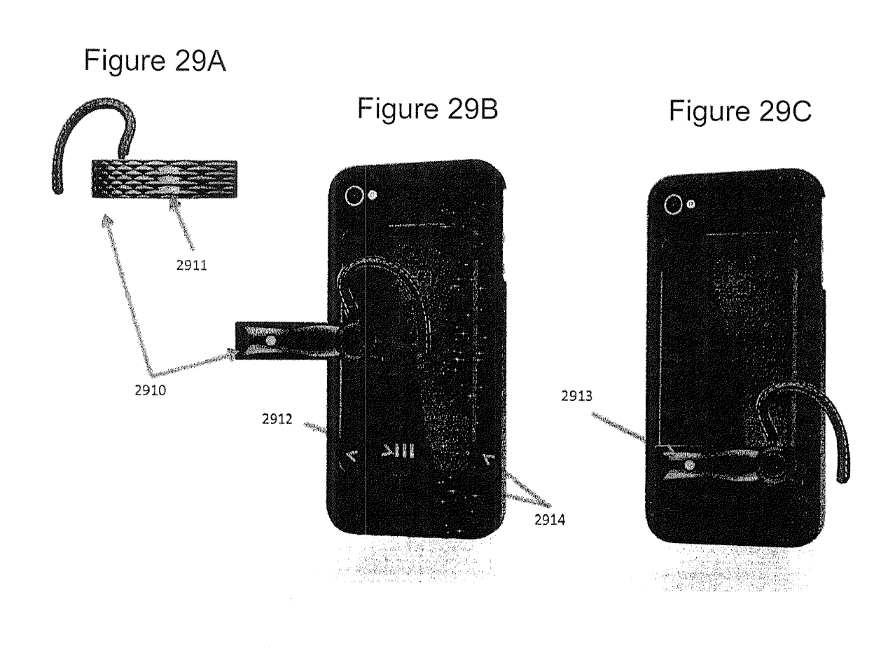

It is also possible to charge external devices directly using IMI contacts. With reference to FIGS. 29A-C, an external device such as Bluetooth headset 2910 may incorporate IMI contacts 2911. Bluetooth headsets 2910, 2913 may be physically attached to the UPM using hooks (3110, shown in FIG. 31), which slide into slots 2914, forming a secure physical connection, as shown in FIG. 29C. When attached to the UPM in this manner, IMI contacts 2911 on the Bluetooth headset are in contact with IMI contacts 2912 on the UPM. The connection between contacts 2911 and 2912 may be used to transfer charge and/or data from the UPM to the Bluetooth headset 2910. Bluetooth headset 2910 is just one example of an external device that may be charged in this manner. Any rechargeable, portable device that incorporates IMI contacts and connectors for attaching to a UPM may be directly charged through the IMI contacts 2912 on the UPM. The portable, external device may be connected to the UPM using any secure attachment mechanism, including but not limited to the hooks-and-slots connection mechanism shown in FIGS. 29A-C, magnetic connections, VelcroTM connectors, hooks, studs, latches, dovetails, snaps, elastics, etc.

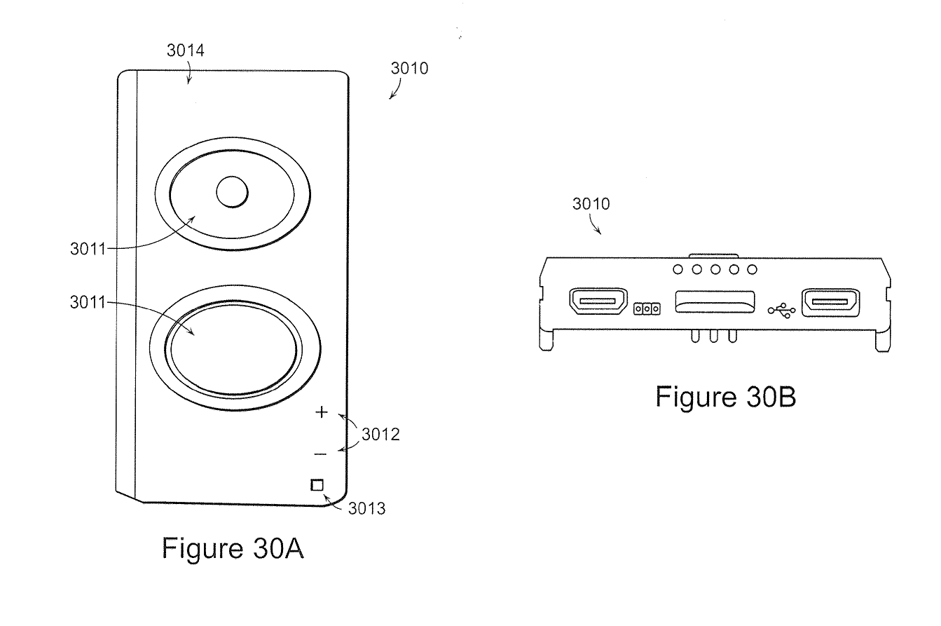

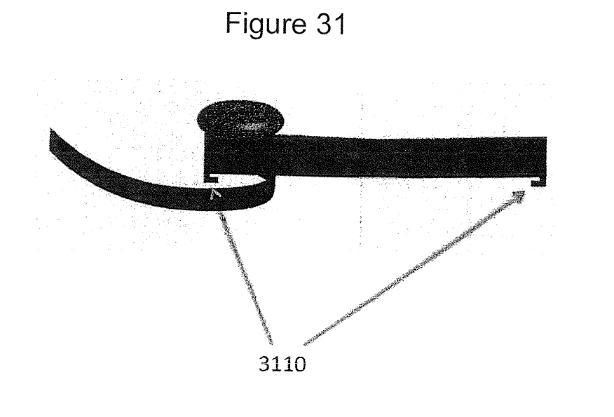

In one embodiment, shown in FIGS. 30A-B, a UPM 3010 may include an audio speaker 3011 in addition to the various other UPM components described above. UPM 3010 includes a Bluetooth interface for transmitting audio signals wirelessly to speaker 3011. UPM 3010 also includes volume controls 3012 for controlling the audio volume, a Bluetooth indicator light 3014 that is lit when a Bluetooth connection is established between the UPM 3010 and a Bluetooth-enabled audio source, and an on/off button 3013 that may be used to selectively enable/disable speakers 3011. As with various embodiments described above, UPM 3010 may be affixed to a case, replacement battery door, another UPM, or directly to a portable device, allowing its internal battery to send/receive charge and/or data via IMI contacts.

The IMI bus is capable of transmitting not only charge, but also data. This data can be used, for example, to communicate among UPMs in order to effect the charge-in, charge-out, and charge-transfer behaviors described above. Transmitting both charge and data using an electrical connector is well known in the art, and may be accomplished using a wide variety of methods. For example, with reference to the IMI connectors shown in FIG. 5 and FIG. 6, two of the three connector elements may be used to transfer charge, while the remaining connector element may be used to transfer data. However, the present invention is not limited to this particular scheme.

An exemplary UPM interfaced with a hand held electronic device is described. For the purpose of this description, the design consists of two reference products, e.g., a power module consisting of a battery and control board in rectangular housing (UPM) and a case (or skin), for example a skin for the iPhone 3GS.

The UPM stores and provides extra power for portable devices. The UPM can connect with a 3 pin IMI bus connector. Additionally, charge can also be transferred to and from the UPM via micro USB connectors in order to charge the UPM or charge external devices.

An exemplary UPM has the following features (note that this list applies to certain embodiments only and is not intended to be exhaustive):
Form is a rectangle 7×44×81 mm
Energy capacity is an 1100 (or larger) mAh rechargeable Lithium Polymer battery
To accept charge, has a micro USB B receptacle
Queries the devices's battery charge state to maximize use of the battery charge
To provide charge, has a micro USB AB receptacle
Connects to the Skin or other UPMs with (1) male and (1) female IMI connectors
Provides a led display of the battery charge level with five LEDs that can be visible from the end and top of the UPM
Has a button to temporarily force display battery state on the LEDs
Will be same form factor across a range of portable device platforms
Has a high efficiency DC/DC converter and battery charger to minimize energy losses during transfers

An exemplary Skin has the following features (note that this list applies to certain embodiments only and is not intended to be exhaustive):
Provides a protective case for the handheld device
Provides a female IMI connector
Provides a micro USB connector to allow the handheld device to synchronize with a PC, MAC or other personal computing device. This connector also allows charging the handheld device and/or the UPM.
Queries the devices's battery charge state to maximize use of the battery charge
Provides a male 30 pin connector to connect to the handheld device
Minimized impact to the antenna performance of the reference phone
Provides an on/off switch on case/skin
Provides overrides to prevent the handheld device from drawing charging current when the internal device battery is fully charged

These products may be used in the following ways (note that this list applies to certain embodiments only and is not intended to be exhaustive):
An UPM may be “snapped” into the Skin or may be attached using another connection mechanism, such as those described above.
More than one UPM may be snapped onto another UPM via IMI that is attached to the Skin.
More than one UPM may be snapped together without a Skin.
A UPM may be connected to an external device and/or an external power source

In one or more embodiments, the UPM interfaces with a power source, a handheld device and other UPM through an IMI bus.

In exemplary embodiments, the IMI bus can include three power/signal pins, such as BUS1, a 5V power bus, BUS2, power and signal ground, and BUS3, control path. In an exemplary embodiment, the UPM has two IMI interfaces, a “leftmost” interface (the female connector) and “rightmost” interface (the male connector), and the BUS1 and BUS2 are hard connected between the left and right most interfaces and the BUS3 goes through a local microprocessor. In some embodiments, a Skin only has the “leftmost” interface.

The UPM can be powered by a variety of sources, such as a local battery if present, a charger connector or a BUS1. A charging protocol can be defined and implemented such that the current consumed by the protocol is as close as possible to the normal battery self drain (e.g., <<1 ma).

In one or more embodiments, the UPM BUS is self configurable, that is, the UPM can identify the components that are connected to the BUS and identify the nature and priority of the connection. Each time the “connection state” changes between UPMs and skins, the devices on the IMI bus communicate and decide on the flow of current in the system. The rules used to determine this are based on a reference model. In this reference model, there are 0 or more UPMs connected to 0 or 1 Skin. A device is defined as either a UPM or a Skin. The “leftmost” device is defined as the UPM which is furthest from the Skin or the one with its female connector exposed. The “rightmost” device is defined as the Skin (if present) or the UPM with its male connector exposed. When the connection state changes, a determination is made if there is a charger plugged into any UPM or skin.

The devices decide which device provides charge:
If a charger exists: the leftmost charger is used.
If no charger exists: then all devices are allowed to “bid” their current battery status. The UPM with the least charge is selected. There is a limitation on the unit to unit accuracy of the UPM's battery charge so there is a tolerance band on comparisons. If two or more have the same charge, the “leftmost” UPM is selected.

The devices decide which UPM takes charge in priority order:
If one or more micro USB A cables are plugged into the micro USB AB connector, the device connected to the rightmost UPM takes priority. This priority continues until all such UPMs are charged.
If present and the Skin believes its device needs charge, charging the device's battery has the next priority.
In the last priority, all devices are allowed to “bid” their current battery status. The UPM with the most charge is selected. Due to the limit on accuracy, there is a tolerance band on comparisons. If two or more have the same charge, the “rightmost” UPM is selected.

The devices also make the above determination on the following events. These actions are also considered change of connection state:
The charger in use is unplugged or turns off.
The device taking charge decides to stop taking charge (for example, the device is full).
A UPM providing charge runs out of charge.

In one or more embodiments, signaling to accomplish the above identified instructions are carried out on a signal wire, e.g., the BUS is a single wire BUS. It is also contemplated that additional wires are used to carry out signaling. In other embodiments, power is transferred in a separate wire. In other embodiments, signaling is imposed on top of the power wire.

The devices can have a variety of interfaces with the user that provide a range of information. For example, LED lights can be provided on the case and/or on the UPM. When displayed, the LEDs provide status on the current charger of the battery, for example:
Off, no charge
1 green LED, <20% charge
2 green LEDs, <40% charge
3 green LEDs, <60% charge
4 green LEDs, <80% charge
5 green LEDs, <100% charge

Pressing the button causes the current charge status to be displayed on the LEDs for 5 seconds. Other events also can also cause the LEDs to temporarily display as well, for example:
Unplugging a UPM
Plugging a UPM into another UPM or Skin
Plugging a charger into a UPM
Plugging a cable to take charge from a UPM

It will be appreciated that while a particular sequence of steps has been shown and described for purposes of explanation, the sequence may be varied in certain respects, or the steps may be combined, while still obtaining the desired configuration. Additionally, modifications to the disclosed embodiment and the invention as claimed are possible and within the scope of this disclosed invention.

What is claimed is:

1. A system for charging a portable electronic device, the system comprising:
a. a battery module comprising:
i. a battery for storing charge;
ii. a charging circuit; and
iii. a first electrical port;
b. a case structured to at least partially enclose an electronic device, the case comprising:
i. connectors adapted to detachably affix the battery module to the case;
ii. a second electrical port adapted to connect to an enclosed electronic device; and
c. an electrical conduit connecting the first electrical port to the second electrical port, said conduit adapted to transfer charge stored in the battery to the second electrical port.

2. The system of claim 1, wherein the electrical conduit is adapted further to transfer data between the first electrical port and the second electrical port.

3. The system of claim 1, wherein the first electrical port is a USB port.

4. The system of claim 1, wherein the second electrical port is a USB port.

5. The system of claim 1, wherein the second electrical port is a 30-pin, multi-function electrical connector.

6. The system of claim 1, wherein the battery module further comprises an electrical input port adapted to receive electrical charge from an external power source.

7. The system of claim 6, wherein the battery module is adapted to store said received electrical charge in the battery.

8. The system of claim 6, wherein the battery module is adapted to transfer said received electrical charge to the second electrical port.

9. The system of claim 1, wherein the battery module further comprises physical connectors adapted to detachably affix an additional battery module to the battery module.

10. The system of claim 9 wherein the battery module further comprises electronic connectors adapted to receive charge stored in an additional battery module.

11. The system of claim 9 wherein the battery module further comprises electronic connectors adapted to transfer charge stored in the battery module to an additional battery module.

12. The system of claim 1, wherein the battery module further comprises physical connectors adapted to detachably affix an external device to the battery module.

13. The system of claim 12, wherein the battery module further comprises electronic connectors adapted to transfer charge stored in the battery module to the external device.

14. The system of claim 1, wherein the battery module includes a single wire, self configurable bus.

15. The system of claim 1, wherein the battery module is configured for DC/DC conversion.

16. The system of claim 1, wherein the back of the case, when a battery module is not attached, is substantially flat.

17. The system of claim 1, wherein the battery module includes an audio actuator device for producing sound.

18. The system of claim 1, wherein the connectors comprise hooks and slots, such that the slots receive the hooks in order to detachably affix the battery module to the case.

19. A system for charging a portable electronic device, the system comprising:
a. a battery module comprising:
i. a battery for storing charge;
ii. a charging circuit; and
iii. a first electrical port;
b. a panel structured to attach to an electronic device, the panel comprising:
i. connectors adapted to detachably affix the battery module to the panel;
ii. a second electrical port adapted to connect to an attached electronic device; and
c. an electrical conduit connecting the first electrical port to the second electrical port, said conduit adapted to transfer charge stored in the battery to the second electrical port.

20. The system of claim 19, wherein the electrical conduit is adapted further to transfer data between the first electrical port and the second electrical port.

21. The system of claim 19, wherein the first electrical port is a USB port.

22. The system of claim 19, wherein the second electrical port is a USB port.

23. The system of claim 19, wherein the second electrical port is a 30-pin, multi-function electrical connector.

24. The system of claim 19, wherein the battery module further comprises an electrical input port adapted to receive electrical charge from an external power source.

25. The system of claim 19, wherein the battery module is adapted to store said received electrical charge in the battery.

26. The system of claim 25, wherein the battery module is adapted to transfer said received electrical charge to the second electrical port.

27. The system of claim 19, wherein the battery module further comprises physical connectors adapted to detachably affix an additional battery module to the battery module.

28. The system of claim 27 wherein the battery module further comprises electronic connectors adapted to receive charge stored in an additional battery module.

29. The system of claim 27 wherein the battery module further comprises electronic connectors adapted to transfer charge stored in the battery module to an additional battery module.

30. The system of claim 19, wherein the battery module includes a single wire, self configurable bus.

31. The system of claim 19, wherein the battery module is configured for DC/DC conversion.

32. The system of claim 19, wherein the back of the panel, when a battery module is not attached, is substantially flat.

33. The system of claim 19, wherein the connectors comprise hooks and slots, such that the slots receive the hooks in order to detachably affix the battery module to the panel.

34. The system of claim 19, wherein the panel may be affixed to an electronic device as a battery panel.

35. The system of claim 19, wherein the battery module includes an audio actuator device for producing sound.

36. A system for charging a portable electronic device, the system comprising:
a. a battery module comprising:
i. a battery for storing charge; and
ii. a first electrical port;
b. a case structured to at least partially enclose an electronic device, the case comprising:
i. connectors adapted to detachably affix the battery module to the case, the connectors comprising hooks and slots;
ii. a second electrical port adapted to connect to an enclosed electronic device; and
c. an electrical conduit connecting the first electrical port to the second electrical port, said conduit adapted to transfer charge stored in the battery to the second electrical port.

37. The system of claim 36, wherein the back of the case, when a battery module is not attached, is substantially flat.

38. A system for charging a portable electronic device, the system comprising:
a. a battery module comprising:
i. a battery for storing charge; and
ii. a first electrical port;
b. a panel structured to attach to an electronic device, the panel comprising:
i. connectors adapted to detachably affix the battery module to the panel, the connectors comprising hooks and slots;
ii. a second electrical port adapted to connect to an attached electronic device; and
c. an electrical conduit connecting the first electrical port to the second electrical port, said conduit adapted to transfer charge stored in the battery to the second electrical port.

39. The system of claim 38, wherein the back of the panel, when a battery module is not attached, is substantially flat and flush with the surface of the electronic device.

40. The system of claim 38, wherein the battery module includes an audio actuator device for producing sound.

41. A stackable power module used for charging an portable device, said stackable power module comprising:
a. a chargeable battery containing stored charge;
b. mechanical connectors used to physically connect the stackable power module with other stackable power modules;
c. electronic connectors used to electronically connect the stackable power module with other stackable power modules;
d. one or more I/O connectors;
e. a memory containing computer-executable instructions to be executed by a processor.

42. The power module of claim 41 wherein the electronic connectors may be used to transfer both charge and data among stackable power modules.

43. The power module of claim 41 wherein at least one of the I/O connectors may be used to charge the battery using an external power source.

44. The power module of claim 41 wherein at least one of the I/O connectors may be used to charge a portable device using stored charge contained in the battery.

45. The power module of claim 41 wherein at least one of the I/O connectors may be used to transmit data to and receive data from a portable device.

46. The power module of claim 41 such that the power module is operable to charge and receive charge from multiple portable devices.

47. The power module of claim 41 further comprising: a detector operable to determine whether the portable device is substantially fully charged; an on/off mechanism operable to turn on and off the transfer of charge from the power module in response to the detector.

48. A housing designed to attach to a mobile device, said housing comprising:
a. A connection assembly intended to receive a universal power module (UPM);
b. Connectors operable to connect a UPM that has been inserted into the connection assembly with battery-charging contacts of a mobile device.

49. The housing of claim 48 wherein the housing comprises a case, said case adapted for receiving the mobile device.

50. The housing of claim 48 wherein the housing replaces the standard battery cover of the mobile device.

51. The housing of claim 48, wherein the connection assembly comprises a region on the housing for receiving a UPM.

52. The housing of claim 51, wherein the region is selected from a cavity or a compartment having at least one raised edge for engaging a UPM.

53. The housing of claim 48, further comprising a connector that provides charge and data communication with a portable device housed within the case.

54. A wireless audio device comprising:
a. mechanical connectors used to physically affix the device to a battery module;
b. an electrical port used to electronically connect the device to a battery module;
c. a battery connected to said electrical port, such that the battery may be charged via said electrical port.
